(19) United States
(12) Patent Application Publication
(10) Pub. No.: US 2014/0279350 A1
(43) Pub. Date: Sep. 18, 2014

(54) TRADING INTERFACE FOR STOP PROTECTION ON OPEN TRADES

(71) Applicant: TD AMERITRADE IP COMPANY, INC., Omaha, NE (US)

(72) Inventors: John D. PETERSEN, Jersey City, NJ (US); Bryan E. SAMPIERI, Jersey City, NJ (US); Victor A. JONES, Chicago, IL (US)

(73) Assignee: TD AMERITRADE IP COMPANY, INC., Omaha, NE (US)

(21) Appl. No.: 13/841,993

(22) Filed: Mar. 15, 2013

(51) Int. Cl. G06Q 40/04

(52) U.S. Cl. CPC G06Q 40/04
USPC 705/37

(57) ABSTRACT

Methods, systems, and apparatuses, including computer programs encoded on computer-readable media, for receiving a create order request from a client. Building a fill order request based on the create order request and comprising a security identifier and a quantity. Extracting a conditional order price from the create order request. Building a conditional order request based on the fill order request and the conditional order price. Sending an open order request to the trading platform, the open order request comprising the fill order request and the conditional order request, wherein the trading platform creates a fill order and a conditional order based on the open order request.

### BACKGROUND

Online trading applications allow users to buy and sell securities using a computing device. FIG. 1 illustrates a block diagram of a trading system. A user can access a web server 104 by using a client 102. The web server 104 can access a trading platform 106. The web server 104 can receive requests from the client 102 and send content to the client 102. For example, the web server 104 can receive a create order request from a client 102, build a fill order request, send the fill order request to the trading platform 106, receive a confirmation from the trading platform 106 in response, and send an indication of the confirmation to the client 102.

Instructions sent to a trading platform can include an order request, such as a fill order request. A fill order request can identify a security, the quantity of the security that a user wishes to purchases, and the price at which the user wishes to purchase. In some cases, stocks may need to be sold if the share value of the stocks falls below a predetermined value. For example, a fill order can exist for a user in which a specified quantity of a particular stock is to be purchased. The trading platform can execute the fill order by purchasing the specified stock. If, however, the stock value decreases by a particular value, the user can determine that the purchased shares should be sold to avoid further loss of value. In such a case, existing systems require that the user submit a sell order for the shares. Because users are required to create and submit a separate sell order request for the shares, the process of selling shares bought in a previous fill order can be cumbersome and inefficient in fast moving markets. Users can contain the risk associated with fast moving markets by reducing the overall time and complexity of creating multiple orders. Additionally, sophisticated investors can create larger strategies more quickly if the complexity of creating second orders is reduced.

### SUMMARY

In general, one aspect of the subject matter described in this specification can be embodied in methods for creating a conditional order in response to receiving a create order request. Receiving a create order request from a client. Building a fill order request based on the create order request and comprising a security identifier and a quantity. Extracting a conditional order price from the create order request. Building a conditional order request based on the fill order request and the conditional order price. Sending an open order request to the trading platform, the open order request comprising the fill order request and the conditional order request, wherein the trading platform creates a fill order and a conditional order based on the open order request. Other implementations of this aspect include corresponding systems, apparatuses, and computer-readable media configured to perform the actions of the method.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of a system in accordance with an illustrative implementation.

FIG. 2 is an illustration of a trading interface based upon a create order request in accordance with an illustrative implementation.

FIG. 3 is a flow diagram of a process for building a conditional order in accordance with an illustrative implementation.

FIG. 4 is a block diagram of a computer system in accordance with an illustrative implementation.

Like reference numbers and designations in the various drawings indicate like elements.

### DETAILED DESCRIPTION

The implementations that follow are aimed at improving the efficiency of executing an order related to a previously executed order. The various implementations can be used with various online trading platforms. In one implementation, a user, by accessing a client 102, can submit a create order request with a conditional order price. The conditional order price may be for a “sell” stop order, i.e. when the price of the security reaches the conditional order price, the security is sold at the market price. The conditional order price may be for a “buy” stop order, i.e., when the price of the security reaches the conditional order price, the security is purchased at the market price. For example, the user can submit a create order request to purchase a quantity of a particular stock. The user can include information with the create order request such that the information can identify the minimum value at which the stock should automatically be sold. The client 102 can send the create order request to a web server 104.

The web server 104 can receive the create order request from the client 102 and build a fill order request and a conditional order request. For example, the web server 104 can receive a create order request to purchase a number of shares of stock ABC, the user can include the number of shares to be purchased, such as, but not limited to, 5,000 or 10,000 shares. The web server 104 can build a fill order request for stock ABC with the number of shares sought, for example, 10,000 shares. The web server 104 can determine if the create order request received from the client 102 includes a conditional order price. If a conditional order price is available in the create order request, the web server 104 can build a conditional order request that can include the conditional order price and the stock information from the fill order request. Thus the conditional order can sell the same number of shares that were bought by the fill order at the conditional order price. The web server 104 can build an open order request that includes both the fill order request and the conditional order request and the send the open order request to the trading platform 106.

The trading platform can create a fill order based on the fill order request included in the open order request and a conditional order based on the conditional order request included in the open order request that is received from the web server 104. In an implementation, a conditional order can be an order that activates if particular requirements are met. For example, the conditional order can be activated if the share price of a stock falls below a particular value, such as, but not limited to, the conditional order price included in the create order request. An activated conditional order can create a new order, cancel another order, or do both. For example, a fill order can be submitted to purchase 10,000 shares of stock ABC at market price. The market value of stock ABC at the time the fill order is created can be $10.00 per share. A conditional order can be created to sell shares bought as a result of the fill order if the share price falls below $9.00. Thus, the shares are automatically sold without the need for the user to manually create a separate sell order. In another example, the conditional order can have a conditional order price above the market value at which the shares were bought. For example, if the market value of the shares is $10.00 per share, the conditional order price can be set at $15.00 per share. Thus, if the market value of the shares meets or exceeds the conditional order price, the conditional order can be triggered and the shares can be sold. In yet another example, the conditional order can sell only a percentage of the shares purchased, thereby allowing a user to set multiple stop market action prices.

FIG. 2 is an illustration of a trading interface based upon a create order request in accordance with an illustrative implementation. A client 102 can display a user interface 202 to a user. The user can enter information related to a new create order request. In an implementation, the user interface 202 can include fields for entry of stock information. For example, the user interface 202 can include a field for a stock or option identifier 204 and the number of shares 206 that should be purchased. The user interface 202 can also include additional fields for the user to enter optional data. For example, a user can indicate that additional fields should be included by toggling a checkbox 208. If the checkbox 208 is toggled to a checked state, the conditional order type dropdown 209 and the conditional order parameter 210 field can be enabled. Once enabled, the user can select the field type using the conditional order type 209 dropdown and enter a value in the conditional order parameter 210 field. In a further example, the conditional order parameter 210 field can be labeled based on the selected conditional order type 209. For example, if the user selects a conditional order type of stop market activation, the conditional order parameter 210 can be labeled as a conditional order price. The number of conditional order parameter 210 fields can vary based on, for example, the type of order being submitted. The conditional order type can be, but is not limited to, a stop market sell order, a stop market buy order, a stop market limit buy order, a trailing stop buy order, a stock market limit sell order, a limit sell order, a trailing stop sell order, or a limit buy order. Thus, a user can select a stop market sell order to be associated as a conditional order with the fill order. Additional optional fields can also be displayed in the same manner (not shown).

FIG. 3 is a flow diagram of a process for building a conditional order in accordance with an illustrative implementation. The process 300 can be implemented on a computing device. In one implementation, the process 300 is encoded on a computer-readable medium that contains instructions that, when executed by a computing device, cause the computing device to perform operations of process 300.

The web server 104 can receive a create order request from a client (302). In an implementation, a web server 104 can receive a create order request from a client 102 to create a fill order on the trading platform 106 at the market price. The create order request can include, for example, the stock or option identifier, the number of shares to be purchased, and a conditional order price. The create order request received from the client can be formatted in any number of ways. For example, the request can be formatted as XML data, wherein the XML data includes all of the data entered by the user at the client 102. In one implementation, the web server 104 can send the create order request to the trading platform 106 (not shown). In another implementation, the web server 104 can create one or more order requests which can be submitted to the trading platform.

The web server 104 can build a fill order request from the create order request (304). In an implementation, the web server 104 can extract data related to the fill order request from the create order request. The web server 104 can create a fill order request and include the data extracted from the create order request received in operation 302. For example, if the create order request includes a stock symbol of ABC and the number of shares is 10,000, the fill order request will be for the stock with the symbol ABC and the number of shares will be set at 10,000. The web server 104 can optionally retrieve additional information not provided by the client 102 and include the additional information in the fill order request. For example, the web server 104 can include a timestamp of the fill order request, a session identifier, a client request identifier, etc.

The web server 104 can determine if a conditional order request should be submitted to the trading platform 106 based, at least, on the inclusion of a conditional order price in the create order request received from the client (310). In an implementation, the web server 104 can determine if the create order request received from the client 102 in operation 302 includes a conditional order price. If a stop order price is not included in the create order request, then the web server 104 can send a request to the trading platform with only the fill order request. If, however, the create order request does include a stop order price, the web server 104 can build a conditional order request and send both the fill order request and the conditional order request to the trading platform 106.

The web server 104 can build a order request using the fill order data and the conditional order price (312). In an implementation, the conditional order request can be for the stock and for the number of shares identified in the create order request and the conditional order price. The conditional order price can be extracted from the create order request. Because the conditional order request includes the stock information directly, the conditional order request is related to the shares of the stock rather than the fill order.

In another implementation, the web server 104 can include a reference to the fill order request in operation 304 in addition to the data in the create order request. The conditional order request can include configuration options to carry out any number of actions including, but not limited to, selling all shares bought in response to the fill order associated with the fill order identifier, selling a percentage of the shares bought in response to the fill order, etc. As discussed above, the conditional order can be activated based on one or more configuration options. For example, a conditional order can be activated if the share price of a particular stock falls below the included conditional order price. In another implementation, the client 102 can provide configuration data for the conditional order in the create order request (e.g., by selecting a conditional order type 209, referring to FIG. 2). For example, the client 102 can set the action that should be taken (e.g., setting the percentage or number of shares that should be sold, etc) and the maximum number of shares, if any, that can be sold.

In one implementation, the conditional order can be a stop market sell order as described above. The conditional order can also be a stop market buy order, a stop market limit buy order, a trailing stop buy order, a stock market limit sell order, a limit sell order, a trailing stop sell order, or a limit buy order. Although certain implementations are described with regard to shares of stock, other types of securities, including but not limited to derivatives such as options and futures and multi-leg trades, may be utilized.

The web server 104 can create and send an open order request with one or more order requests to the trading platform (314). In an implementation, the trading platform 106 can receive the open order request and create orders based on each of the received order requests. For example, if the open order request includes a fill order request and a conditional order request, the trading platform 106 can open a fill order and a conditional order. The trading platform 106 can respond to the open order request with an open order confirmation.

The web server 104 can receive the open order confirmation from the trading platform 106 (316). In an implementation, the trading platform 106 can send identifiers for the fill order and conditional order. The open order confirmation can also include additional information about each order request, such as, but not limited to, the status of the fill order and the status of the conditional order.

In one implementation, the trading platform may perform a check regarding the account associated with the conditional order upon the trigger of the underlying condition, i.e. if the stock price is the conditional order price. For example, where the conditional order is a stop market sell order, the account can be checked to determine if the necessary shares are owned. In another example, if the fill order request is canceled or rejected for some reason, the conditional order request can also be canceled. In a further example, if the conditional order request cannot be sent to the market, then it can be canceled. The user can receive a notification of the cancellation or rejection of any order request. The status of a conditional order can be updated to reflect the state of the order including, but not limited to, “pending”, “open”, or “closed”.

The web server 104 can send a create order confirmation to the client (318). In an implementation, the web server 104 can determine the outcome of the create order request based on the fill order request confirmation and the conditional order request confirmation. For example, both the fill order request and the conditional order request can have succeeded. Thus, the web server 104 can build a create order confirmation indicating that the fill order and the conditional order were created. In another example, if the web server 104 determines that no stop market activation price was received (310), the web server 104 can send a create order confirmation that the fill order was created and a conditional order request was not submitted to the trading platform 106.

FIG. 4 is a block diagram of a computer system in accordance with an illustrative implementation. The computer system or computing device 400 can be used to implement cell phones, clients, servers, cloud computing resources, etc. The computing system 400 includes a bus 405 or other communication component for communicating information and a processor 410 or processing circuit coupled to the bus 405 for processing information. The computing system 400 can also include one or more processors 410 or processing circuits coupled to the bus for processing information. The computing system 400 also includes main memory 415, such as a random access memory (RAM) or other dynamic storage device, coupled to the bus 405 for storing information, and instructions to be executed by the processor 410. Main memory 415 can also be used for storing position information, temporary variables, or other intermediate information during execution of instructions by the processor 410. The computing system 400 may further include a read only memory (ROM) 410 or other static storage device coupled to the bus 405 for storing static information and instructions for the processor 410. A storage device 425, such as a solid state device, magnetic disk or optical disk, is coupled to the bus 405 for persistently storing information and instructions.

The computing system 400 may be coupled via the bus 405 to a display 435. An input device 430, such as a keyboard, may be coupled to the bus 405 for communicating information and command selections to the processor 410. In another implementation, the input device 430 has a touch screen display 435. The input device 430 can include a cursor control, such as a mouse, a trackball, or cursor direction keys, for communicating direction information and command selections to the processor 410 and for controlling cursor movement on the display 435.

According to various implementations, the processes described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Moreover, the separation of various system components in the implementations described above should not be understood as requiring such separation in all implementations, and it should be understood that the described program components and systems can generally be integrated in a single software product or packaged into multiple software products.

Similarly, while operations are depicted in the drawings in a particular order, this should not be understood as requiring that such operations be performed in the particular order shown or in sequential order, or that all illustrated operations be performed, to achieve desirable results. Thus, particular implementations of the subject matter have been described. Other implementations are within the scope of the following claims.

What is claimed is:

1. A method comprising:
receiving, using a processor, a create order request from a client;
building a fill order request that is based on the create order request and comprising a security identifier and a quantity;
extracting a conditional order price from the create order request;
building a conditional order request based on the fill order request and the conditional order price;
sending an open order request to the trading platform, the open order request comprising the fill order request and the conditional order request, wherein the trading platform creates a fill order and a conditional order based on the open order request.

2. The method of claim 1, wherein the security identifier is a stock identifier and the quantity is a quantity of shares.

3. The method of claim 2, further comprising:
determining the market value of a stock associated with the stock identifier equal to or below the conditional order price; and
activating the conditional order.

4. The method of claim 3, wherein activating the conditional order comprises creating a sell order, wherein the sell order comprises the stock identifier and the quantity of shares.

5. The method of claim 4, wherein the sell order sells the quantity of shares of the stock at a market price.

6. The method of claim 3, wherein activating the conditional order comprises creating a sell order, wherein the sell order comprises the stock identifier and a second quantity of shares, wherein the second quantity of shares is less than the quantity of shares.

7. The method of claim 3, wherein activating the conditional order comprises creating a sell order, wherein the sell order comprises the stock identifier and a percentage of the quantity of shares, wherein the percentage of the quantity of shares of the stock are sold.

8. The method of claim 2, further comprising:
determining the market value of a stock associated with the stock identifier is equal to or above the conditional order price; and
activating the conditional order.

9. The method of claim 1, further comprising:
receiving an open order confirmation from the trading platform;
sending, to the client, an order confirmation based on the open order confirmation.

10. The method of claim 1, further comprising sending user interface information to a client, wherein the client generates a create order user interface based on the user interface information, wherein the generated user interface comprises a toggle field, a conditional order type field, and at least one conditional order parameter field, and wherein the create order request is populated using the generated create order user interface.

11. A system comprising:
one or more processors configured to:
receive a create order request from the client;
build a fill order request that is based on the create order request and comprising a security identifier and a quantity;
extract a conditional order price from the create order request;
build a conditional order request based on the fill order request and the conditional order price;
send an open order request to the trading platform, the open order comprising the fill order request and the conditional order request, wherein the trading platform creates a fill order and a conditional order based on the open order request.

12. The system of claim 11, wherein the security identifier is a stock identifier and the quantity is a quantity of shares.

13. The system of claim 12, wherein the one or more processors are further configured to:
determine the market value of a stock associated with the stock identifier is equal to or below the conditional order price; and
activate the conditional order.

14. The system of claim 13, wherein activating the conditional order comprises creating a sell order, wherein the sell order comprises the stock identifier and the quantity of shares.

15. The system of claim 14, wherein the sell order sells the quantity of shares of the stock at a market price.

16. The system of claim 13, wherein activating the conditional order comprises creating a sell order, wherein the sell order comprises the stock identifier and a second quantity of shares, wherein the second quantity of shares is less than the quantity of shares.

17. The system of claim 13, wherein activating the conditional order comprises creating a sell order, wherein the sell order comprises the stock identifier and a percentage of the quantity of shares, wherein the percentage of the quantity of shares of the stock are sold.

18. The system of claim 12, wherein the one or more processors are further configured to:
determine the market value of a stock associated with the stock identifier is equal to or above the conditional order price; and
activate the conditional order.

19. The system of claim 11, wherein the one or more processors are configured to:
receive an open order confirmation from the trading platform;
send, to the client, an order confirmation based on the open order confirmation.

20. A non-transitory computer-readable medium having instructions stored thereon, wherein the instructions comprise:
instructions to receive a create order request from a client;
instructions to build a fill order request that is based on the create order request and comprising a security identifier and a quantity of shares;
instructions to extract a conditional order price from the create order request;
instructions to build a conditional order request based on the fill order request and the conditional order price;
instructions to send an open order request to the trading platform, the open order request comprising the fill order request and the conditional order request, wherein the trading platform creates a fill order and a conditional order based on the open order request.
